(19) United States
(12) Patent Application Publication
(10) Pub. No.: US 2005/0066570 A1
(43) Pub. Date: Mar. 31, 2005

(54) Gas tip and gas tip holder for a mosquito trap

(75) Inventors: Robert F. Mosher II, Wichita, KS (US); Franklin Schmidt, Mulvane, KS (US)

Correspondence Address: LEYDIG, VOIT & MAYER, LTD.;(SEATTLE OFFICE), TWO PRUDENTIAL PLAZA, SUITE 4900, CHICAGO, IL, 60601-6780, US

(73) Assignee: The Coleman Company, Inc., Wichita, KS (US)

(21) Appl. No.: 10/940,826

(22) Filed: Sep. 14, 2004

Related U.S. Application Data
(60) Provisional application No. 60/505,769, filed on Sep. 25, 2003.
(60) Provisional application No. 60/558,340, filed on Mar. 31, 2004.

(51) Int. Cl. A01M 1/02; A01M 1/06

(52) U.S. Cl. 43/139

(57) ABSTRACT

A trap for mosquitos or biting insects. The trap utilizes combustion to generate CO2, which is used as an attractant. An elongate gas tip holder is provided for the mosquito trap and is removable without disassembly of the mosquito trap and with one or no tools. Combustion gases are routed down a column of the mosquito trap to a diffuser located in the base. An attractant such as octenol may be mounted in the column. A circuit is also provided for indicating operation of the mosquito trap.

### CROSS REFERENCE TO RELATED APPLICATIONS

This patent application claims priority to U.S. provisional Patent Application No. 60/505,769 filed Sep. 25, 2003, and 60/558,340 filed Mar. 31, 2004, both of which are incorporated herein in their entireties.

### TECHNICAL FIELD OF THE INVENTION

The present invention relates to insect traps, and more particularly to devices for attracting, and trapping or killing, mosquitos and other biting insects.

### BACKGROUND OF THE INVENTION

Biting insects, such as mosquitos and flies, can be an annoying, serious problem in man's domain. They interfere with work and spoil hours of leisure time. Their attacks on farm animals can cause loss of weight and decreased milk production. Worldwide, mosquito-borne diseases kill more people than any other single factor. Mosquitos can be carriers of malaria, yellow fever, and dengue fever in humans.

In the United States, mosquitos spread several types of encephalitis, including the West Nile virus. They also transmit heart worms to cats and dogs.

People are not the primary blood hosts for mosquitos and biting insects, especially in temperate climates. The major mosquito pests in the southeastern United States seem to prefer the host-odor of small herbivorous (vegetarian) mammals, such as rabbits, or birds. Mosquitos that carry encephalitis seem to prefer avian (bird) blood hosts. These mosquitos bite people when they get the chance, but they are better at tracking the scent of animals that are most abundant in their habitat.

Mosquitos locate blood hosts by scent, sight, and heat. From 100 feet away (30 meters) mosquitos can smell a potential blood host's scent, especially the carbon dioxide (CO₂) the blood host exhales. Similarly, biting flies can smell their prey from 300 feet (100 meters) away. Because CO₂ is present in the atmosphere (plants take in CO₂ and give off oxygen, and animals take in oxygen and give off CO₂), mosquitos respond to higher-than-normal concentrations, especially when the CO₂ is mixed with host-odor. Mosquitos follow a blood host's scent upwind, and can see a target at a distance of about 30 feet (10 meters).

People have tried a number of different methods to rid themselves of mosquitos and other biting insects. One method that is often utilized is spraying or applying chemical insecticides. Although many chemicals work well to kill or repel mosquitos, the chemicals often have a deleterious effect on the environment, including, but not limited to, killing beneficial insects. In addition, chemical insecticides are effective only for a limited amount of time, and thus must be continuously sprayed. Moreover, many types of mosquitos and biting insects are capable of developing resistance to chemical pesticides in a few generations (which may be only a few months for mosquitos), and in the long run, that adaptation makes the species stronger.

Citronella candles and smoking coils are often used to repel mosquitos and other insects. However, research has shown that, in general, an individual must stand within the smoky plume of the citronella to be protected. This, of course, is not desirable. Moreover, even when standing in the plume, citronella is only partially effective in reducing the probability of a mosquito bite. Encouraging natural predation of insects by setting up bird or bat houses in one's backyard has also been unsuccessful in reducing local mosquito populations.

Recently, significant research and effort have been expended to develop devices that attract and trap or kill mosquitos. In general, these devices attempt to replicate the mosquito-attracting attributes of a typical blood host, such as a rabbit or a bird. The devices may include, for example, a source of carbon dioxide, a source of octenol (an alcohol that is given off by mammalian blood hosts), and/or a heat source.

One such device is sold under the trademark “MOSQUITO MAGNET” and is described in U.S. Pat. No. 6,145,243 to Wigton et al. The MOSQUITO MAGNET apparatus is an insect trapping device that generates its own insect attractants of carbon dioxide (CO₂), heat, and water vapor through catalytic conversion of a hydrocarbon fuel in a combustion chamber. The hot insect attractants generated in the combustion chamber are diluted and cooled to a temperature above ambient temperature and below about 115 degrees Fahrenheit (F) by mixing with air, and the mixture is exhausted downward through an exhaust tube. A counterflow of outside air is drawn into the trap though a suction tube that concentrically surrounds the exhaust tube. Biting insects are sucked into the suction tube and are captured in a porous, disposable bag connected to the other end of the suction tube.

Additional chemical attractants may be used with the device to make the trap even more effective.

Although the MOSQUITO MAGNET device works well for its intended purpose, due to the high suggested retail price, especially for its cordless models, it is far out of reach of the ordinary consumer. Thus, few people would actually purchase the MOSQUITO MAGNET, even if they have a pressing need for mosquito control.

Another example of an apparatus for attracting and destroying insects is disclosed in U.S. Pat. No. 6,055,766, and is sold under the trademark DRAGONFLY. The DRAGONFLY apparatus generally includes a source of carbon dioxide, a source of octenol, a device for emitting the carbon dioxide proximate the source of octenol to create a mixture of the carbon dioxide and octenol, a heating element, and an electrified grid. Insects are initially attracted to the apparatus by the odor associated with the mixture of carbon dioxide and octenol. As the insects fly closer to the apparatus, they are further attracted to the visual properties of the apparatus and then, at close range, they are attracted to the heat emitted by the heating element. In an attempt to fly closer to the heating element, the insects are intercepted by the electrified grid and destroyed.

Although the DRAGONFLY apparatus works well for attracting and capturing insects, its heating source and electrical grid are reliant upon an AC power supply, and thus the portability of the DRAGONFLY apparatus is limited to locations that can be reached by an electrical extension cord. This feature limits the use of the DRAGONFLY apparatus mostly to home use, and even limits the locations where it may be located around a home. Moreover, as with the MOSQUITO MAGNET device, the DRAGONFLY apparatus has a pricing point out of the range of the ordinary consumer.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with an embodiment of the invention, an elongate gas tip holder is provided for a mosquito trap. The elongate gas tip holder may be mounted without disassembly of the mosquito trap.

In accordance with an embodiment of the invention, the elongate gas tip holder is mounted within a tubular heat exchanger. Gas enters the tubular heat exchanger, thereby cooling the elongate gas tip holder. The gas enters the elongate gas tip holder through at least one opening and flows out of a gas tip and into a combustion chamber.

In accordance with an embodiment of the invention, the elongate gas tip holder attaches to the tubular heat exchanger through the use of a single tool or by using no tools. Threads may be provided for threading the elongate gas tip holder into the tubular heat exchanger.

In accordance with an embodiment of the invention, at least one O-ring is provided on the elongate gas tip holder for engaging an inner surface of the tubular heat exchanger. If multiple O-rings are provided, these O-rings may successively engage the inside of the tubular heat exchanger so as to provide progressive resistance to insertion of the elongate gas tip holder. The O-rings also align the elongate gas tip holder in the tubular heat exchanger so that the possibility of cross threading is minimized.

In accordance with an embodiment, a microporous filter is installed where it may filter gas entering the gas tip holder. The microporous filter may be mounted, for example, between the gas tip holder and the tubular heat exchanger. In an embodiment, the microporous filter is formed from plastic, such as an ultra high molecular weight polyethylene.

In accordance with another embodiment, a bug and debris guard may be used to prevent spiders, other insects, and foreign matter from entering the gas tip holder. The bug and debris guard may be, for example, mounted on the outside of the tubular heat exchanger.

In accordance with an embodiment of the invention, a thermoelectric valve is utilized for supplying gas to a combustion chamber of a mosquito trap. The thermoelectric valve includes a manual button for opening the valve, thereby allowing gas to flow therethrough, and an electronic device, such as an electromagnet, for holding the valve open. The electronic device is connected to a heat sensor, such as a thermocouple, which when heated provides a current to the electronic device to hold the valve open. A circuit is provided for indicating to a user that the combustion chamber has reached a particular temperature so that the user no longer has to hold the button on the thermoelectric valve. The circuit provides a signal via a signal device to a user that the combustion chamber has reached a particular temperature. In accordance with an embodiment of the invention, the signal device is powered via a battery, and the battery is charged by thermoelectric modules connected to the combustion chamber.

In accordance with an embodiment of the invention, the circuit is arranged so that it acts based upon alternating signals provided to the circuit. On a first alternating signal, the battery is charged by the thermoelectric modules. On a second alternating signal, the battery provides power to the signal device. The signal device may be, for example, a lamp, an LED, or another suitable device.

In accordance with another embodiment of the invention, two batteries are used, and the signals are alternated so that one of the batteries is providing power to the signal device and the other battery is being charged at all times.

In accordance with an embodiment of the invention, combustion gasses are generated by a combustion process, and are routed from an upper housing of the mosquito trap to a base for the mosquito trap. The base is positioned close to the ground, and the gasses may be routed, for example, down a column that supports the upper housing for the mosquito trap.

In accordance with an embodiment of the invention, a diffuser is provided at the bottom of the column for directing gasses in a sideways direction substantially perpendicular to the intake flow into a vacuum inlet for the mosquito trap. The diffuser may include, for example, a mesh screen extending between the edges of two separated discs.

In accordance with an embodiment of the invention, an attractant, such as octenol, is provided in the column. An attractant door may be provided in the column for inserting additional attractant in the column.

In accordance with another embodiment of the invention, a heat exchanger is connected to the combustion chamber and air is directed through the heat exchanger for cooling of the heat exchanger and for providing air for mixing with combustion gasses from the combustion chamber. The air flowing into the heat exchanger is divided and sent upward by a straightener, or a series of walls that direct the air upward in a uniform pattern.

In accordance with another embodiment of the invention, a capture jar is provided for the mosquito trap.

The capture jar includes a door which, in a first position, closes to deny access to the inside of a trap within the capture jar and, in a second position, opens to provide access to the inside of the trap. The door opens and closes as a result of installing the capture jar on the mosquito trap.

In accordance with another embodiment of the invention, the capture jar includes a removable end panel to which a net bag attaches. The end panel includes a closable door so that insects may not be released from the combined end panel and net bag. If desired, a first end panel and net bag may be set aside, and a second end panel may be utilized with another net bag for continuing operation of the mosquito trap while the insects in the first net bag are allowed to die.

In accordance with an embodiment of the invention, the net bag may be impregnated with an attractant such as octenol. The attractant that is impregnated in the bag may be provided in sufficient amounts so that the attractant is used at about the time that the net bag needs replacement. As such, most maintenance for the mosquito trap is performed by replacement of the bag.

In accordance with another embodiment of the invention, a net bag may include a pocket or other structure for receiving an attractant, such as an attractant tray. The attractant may be placed in the pocket when the net bag is installed, and may be checked for need of replacement when a user empties or replaces the bag. The pocket may include a closure mechanism, such as a hook and loop fastener or other suitable closure.

In accordance with an embodiment of the invention, attractant may be provided in a container having several removable panels. Removal of individual panels or a series of individual panels provides a selected amount of attractant for the stream. Also, if desired, different kinds of attractants may be included underneath different panels. In this manner, a user may open particular panels in accordance with the insects the user desires to attract and kill. A color coding or other system may be provided for informing the user which panels should be removed for a particular region, particular conditions, or for particular insects.

Other features of the invention will become apparent from the following detailed description when taken in conjunction with the drawings, in which:

### BRIEF DESCRIPTION OF THE DRAWINGS

FIG. 1 is a side perspective view of a mosquito trap in accordance with an embodiment of the invention;

FIG. 2 is a side perspective view of the mosquito trap of FIG. 1, with a cover removed to show detail;

FIG. 3 is a cutaway view of the mosquito trap of FIG. 1, showing airflow through the mosquito trap;

FIG. 4 is an exploded side perspective view of a gas tip holder and tubular heat exchanger that may be utilized in the mosquito trap of FIG. 1;

FIG. 5 is a cutaway view showing the gas tip holder of FIG. 4 inserted into the tubular heat exchanger;

FIG. 6 is an exploded side perspective view of a combustion assembly for the mosquito trap of FIG. 1;

FIG. 7 is an exploded rear side perspective view of the mosquito trap of FIG. 1;

FIG. 8 is an exploded side perspective view of a capture jar for the mosquito trap of FIG. 1;

FIG. 9 is a side perspective view of an end panel for the capture jar of FIG. 8, showing the end panel attached to a nose piece of the mosquito trap of FIG. 1;

FIG. 10 is a side perspective view of the end panel of FIG. 9;

FIG. 11 is a rear side perspective view of the end panel of FIGS. 9 and 10;

FIG. 12 is a cutaway view of the capture jar of FIG. 8, with the capture jar assembled;

FIG. 13 is a block diagram representing a thermoelectric valve that is utilized for gas flow in the mosquito trap of FIG. 1 in accordance with an embodiment of the invention;

FIG. 14 is an astable multivibrator circuit utilized in accordance with an embodiment of the invention;

FIG. 15 is a first circuit utilized to light a lamp in accordance with an embodiment of the invention;

FIG. 16 is a second circuit utilized to light a lamp in accordance with an embodiment of the invention;

FIG. 17 is an exploded side perspective view of an alternate embodiment of a gas tip holder and tubular heat exchanger for a mosquito trap, including a microporous filter and a bug and debris screen;

FIG. 18 is a cross-sectional view of the assembled gas tip holder and tubular heat exchanger of FIG. 17;

FIG. 19 is a side perspective view of an attractant tray in accordance with an embodiment of the invention;

FIG. 20 is a side perspective view of a net bag in accordance with an embodiment of the invention; and

FIG. 21 is a side perspective view of a combustion chamber and heat exchanger showing a shim for controlling carbon dioxide concentration in accordance with an embodiment of the invention.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

At the outset, it is important to note a few characteristics of mosquitos and flying insects. Typically, biting insects are attracted by the odor of kairomones, which are chemicals given off by blood hosts and which are attractants to biting insects. Kairomones include carbon dioxide exhaled by both mammalian and avian blood hosts and octenol, an alcohol which is given off by mammalian blood hosts. Biting insects locate a blood host by tracking the carbon dioxide plume created by the blood host. A mixture of carbon dioxide and octenol is particularly attractive to insects seeking mammalian blood hosts.

As a biting insect approaches a blood host, it is attracted to the heat that is emanated from the blood host. Mosquitos and biting insects respond to a narrow range of temperature, typically about approximately 95 to 115 degrees Fahrenheit.

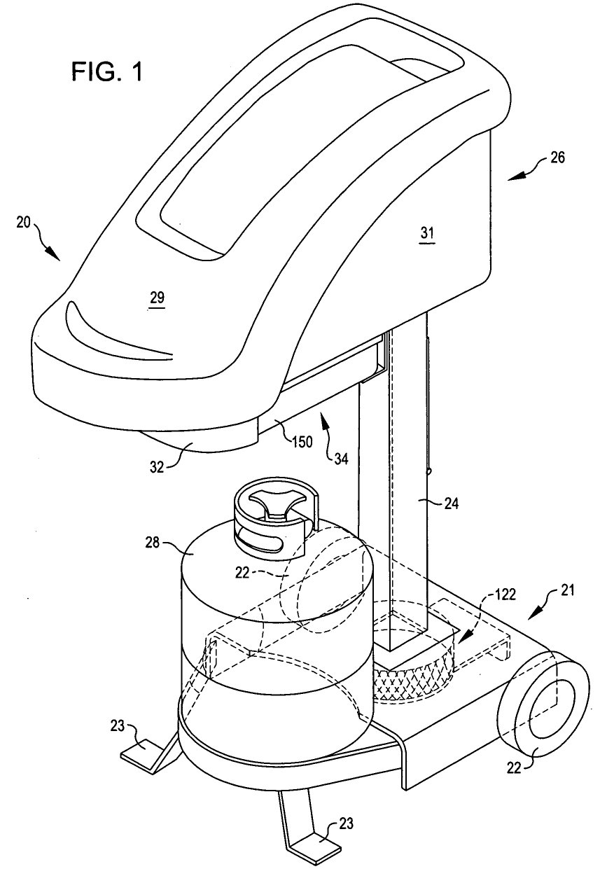

Referring now to the drawings, in which like reference numerals represent like parts throughout the several views, FIG. 1 shows a mosquito trap 20 in accordance with an embodiment of the invention. In general, the mosquito trap 20 is configured and designed to lure and trap mosquitos and/or other biting insects. Although described as a mosquito trap, the mosquito trap 20 may also kill, instead of trapping mosquitos, and may additionally or alternatively catch or kill other insects, such as biting insects. However, for convenience here and in the claims, the phrase “mosquito trap” is meant to cover all such devices.

The mosquito trap 20 includes a base 21 having wheels 22 and feet 23. The wheels 22 and the feet 23 are arranged and configured so that the mosquito trap 20 may be supported thereon. Moreover, the mosquito trap 20 may be tilted and rolled about on the wheels 22 so as to position the mosquito trap 20 in a desired location.

A column 24 extends upward from the base 21 to an upper housing 26. In the embodiment shown in FIG. 1, an LP cylinder 28 is mounted on the base 21. As is known, LP cylinders typically include a combustible gas, such as propane, stored under low pressure. Although this invention is described as utilizing propane, other combustible gasses may be used. Moreover, although the embodiment shown in the drawings utilizes an LP cylinder, other gas sources may be used, such as a gas line or solid fuel sources, for example.

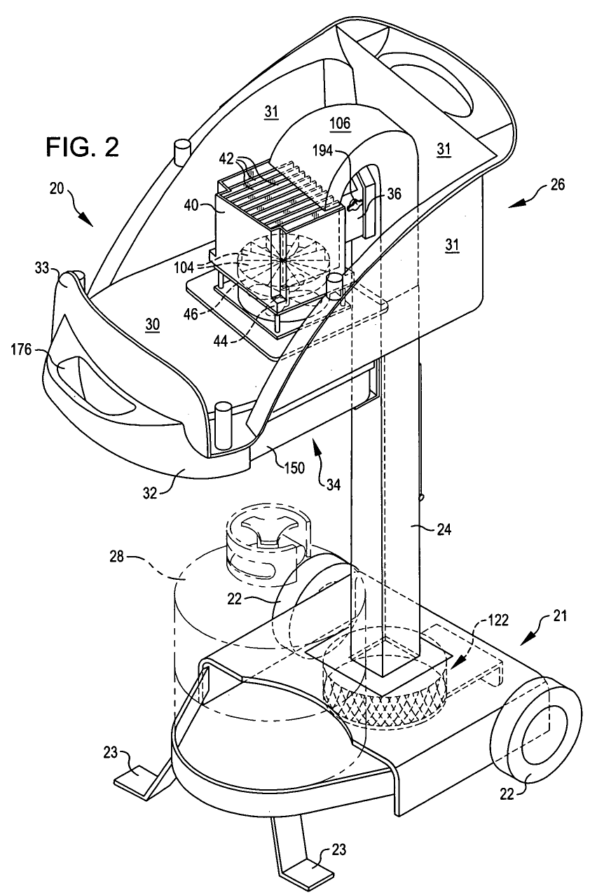

The upper housing 26 includes a cover 29, which is removed in FIG. 2. A bottom plate 30 extends along the lower portion of the upper housing 26. Side walls 31 extend around the bottom plate 30 and extend upward from the left and right sides and the rear of the bottom plate 30. A nose piece 32 extends downward from the front of the bottom plate 30, and a restraining wall 33 extends upward from a front edge of the bottom plate 30. A capture jar 34 fits under the bottom plate 30 between the nose piece 32 and the column 24. The capture jar 34 is further described below.

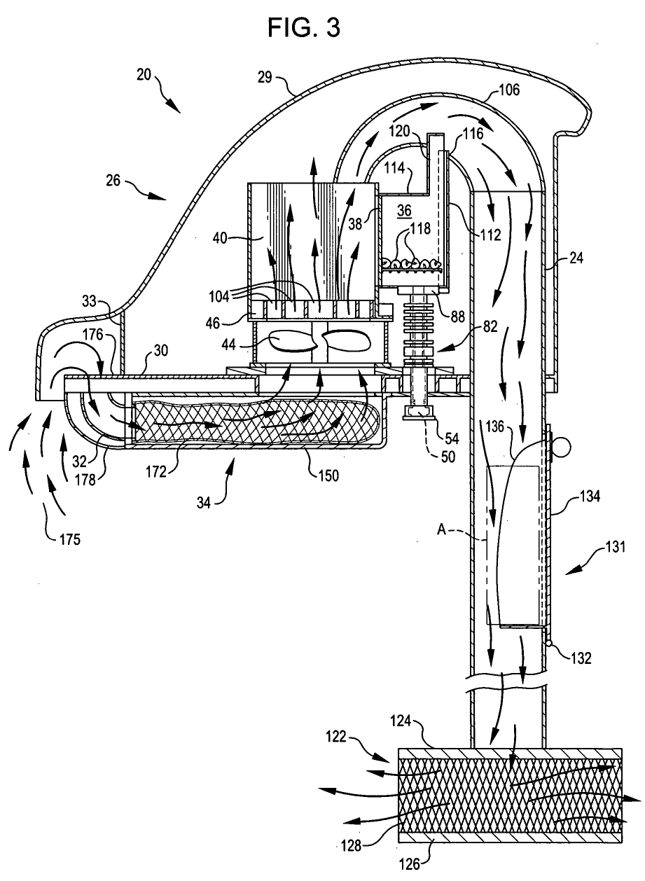

Turning now to FIGS. 2 and 3, the mosquito trap 20 includes a combustion chamber 36. The combustion chamber 36 is mounted inside the upper housing 26, and is connected to thermoelectric modules 38. A heat exchanger 40 is attached to the opposite side of the thermoelectric modules 38. The combustion chamber 36 operates as a heat sink for the thermoelectric modules 38, and the heat exchanger 40 operates as a cold sink for the thermoelectric modules 38. As such, as is known, a change in temperature across the thermoelectric modules 38 between the combustion chamber 36 and the heat exchanger 40 causes electricity to be produced by the thermoelectric modules 38. This electricity may be utilized to operate the electrical components of the mosquito trap 20, as is further described below.

The heat exchanger 40 includes vertical cooling fins 42 extending along its height. A fan 44 is mounted on the bottom of the heat exchanger 40 and is arranged and configured to blow air upward and through the vertical cooling fins 42. A straightener 46 is positioned between the fan 44 and the vertical cooling fins 42. The function of the straightener 46 is described below.

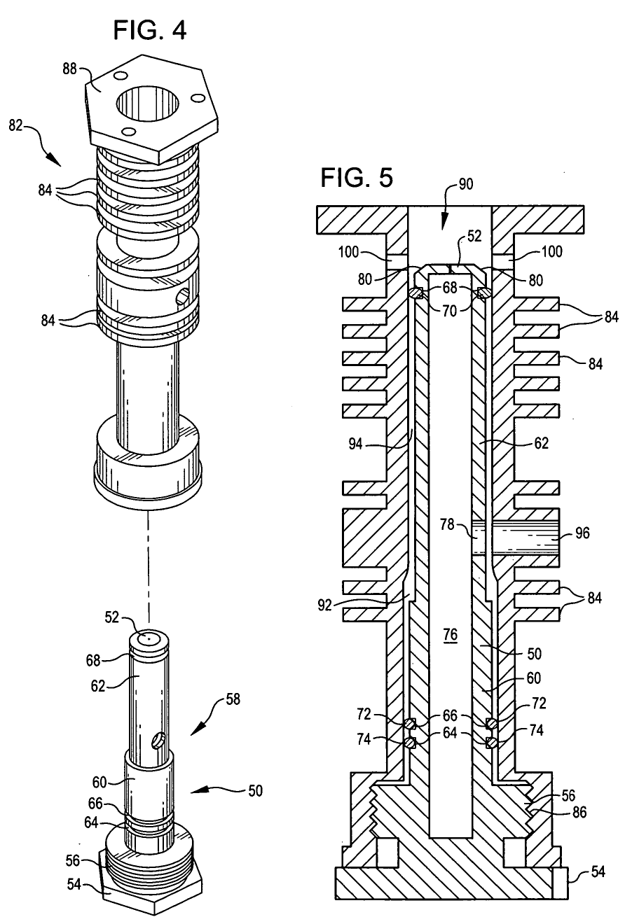

In accordance with an embodiment of the invention, an easily removable gas tip holder 50 (best shown in FIG. 4) is provided for the mosquito trap 20. The gas tip holder 50 includes a gas tip 52. The gas tip 52 includes an orifice through which gas is emitted into the combustion chamber 36. The gas tip 52 may be formed integrally with the gas tip holder 50, or may formed as a separate piece. If separate, the gas tip 52 may be removable or may be permanently attached.

In the embodiment shown, the gas tip holder 50 includes a tool receiving structure 54 at its distal end which is located at the bottom of the gas tip holder 50. The tool receiving structure 54 in the embodiment shown is shaped like a nut; however, other shapes may be utilized for the tool receiving structure 54. As nonlimiting examples, the tool receiving structure 54 may be any configuration designed to be engaged by a tool, such as a hex key opening or a screwdriver slot. Alternatively, as described below, a structure may be provided for hand removal of the gas tip holder 50.

External threads 56 are positioned axially upward from the tool receiving structure 54. A shank 58 having a circular cross section extends upward from the portion of the gas tip holder 50 having the external threads 56. A first portion 60 of the shank 58 has a larger diameter than a second portion 62. The second portion 62 is positioned adjacent to the gas tip 52, and the first portion 60 is positioned adjacent to the external threads 56.

First and second external circumferential grooves 64, 66 extend around the first portion 60 of the shank 58. A third circumferential groove 68 extends around an upper end of the second portion 62 of the shank 58. O-rings 70, 72, 74 (FIG. 5) fit into the grooves 68, 66, 64, respectively.

The gas tip holder 50 includes a hollow passage 76 extending along a majority of its length. An opening 78 extends from the hollow passage 76 out of a side of the second portion 62 of the shank 58.

The top of the gas tip holder 50 preferably includes beveled edges 80. The function of the beveled edges 80 is described further below.

In accordance with an embodiment of the invention, the gas tip holder 50 is mounted within a tubular heat exchanger 82. The tubular heat exchanger 82 is cylindrical in shape and includes external fins 84, each of which extends radially and circumferentially. The external fins are spaced along the length of the tubular heat exchanger 82. In a bottom portion of the tubular heat exchanger 82 are included internal threads 86, which are configured and arranged to receive the external threads 56 of the gas tip holder 50. If desired, however, the gas tip holder 50 may connect to the tubular heat exchanger 82 by another method, such as by snap lock, detent and pin, or another suitable structure. A connector plate 88 is positioned at the opposite end of the tubular heat exchanger 82, and is configured and arranged to attach to a bottom portion of the combustion chamber 36.

The tubular heat exchanger 82 includes a hollow passage 90 extending axially along its length. A first portion 92 of the hollow passage 90 has a larger diameter than a second portion 94. The first portion 92 of the hollow passage 90 is positioned closer to the internal threads 86, and the second portion 94 is positioned closer to the connector plate 88.

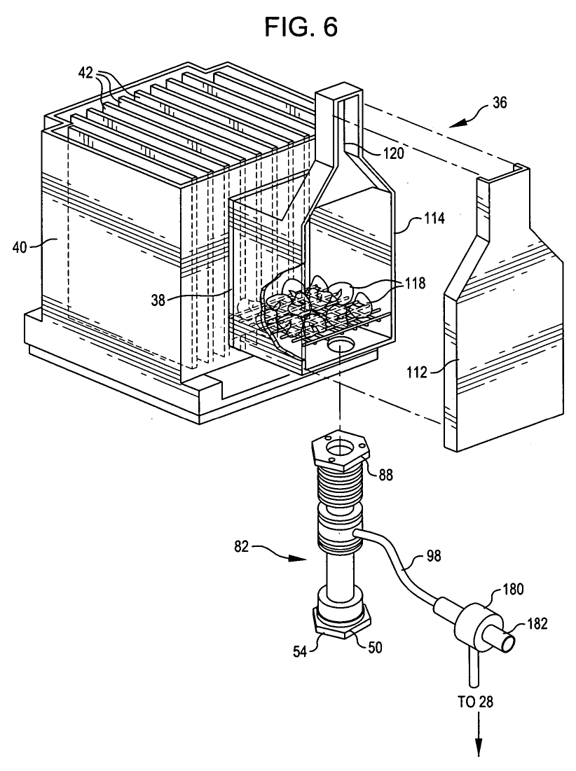

An opening 96 extends through a side of the tubular heat exchanger 82 and communicates with the hollow passage 90. A gas line 98 (shown only in FIG. 6) connects to the opening 96 and leads to the LP cylinder 28.

A series of Venturi holes 100 are spaced around the tubular heat exchanger 82. The Venturi holes 100 are preferably positioned so that they surround the gas tip 52 when the gas tip holder 50 is fully inserted into the tubular heat exchanger 82.

When installed, in the embodiment shown in the drawings, the tubular heat exchanger 82 extends from the bottom of the combustion chamber 36 to and through the bottom plate 30 of the upper housing 26. The lower end of the tubular heat exchanger 82 may be mounted flush with the bottom of the bottom plate 30, may extend only to the top of the bottom plate 30 (wherein a hole is provided through the bottom plate 30 for accessing the tubular heat exchanger 82), or may extend out of the bottom plate 30, such as is shown in FIG. 3.

In either event, the hollow passage 90 of the tubular heat exchanger 82 is preferably open to ambient air when the gas tip holder 50 is not installed in the tubular heat exchanger 82.

The gas tip holder 50 and the tubular heat exchanger 82 are elongate in the drawings, but may be proportioned as needed for an application. Also, the gas tip holder 50 may be shorter than, longer than, or approximately the same length as the tubular heat exchanger 82.

To install the gas tip holder 50 in the tubular heat exchanger 82, a user grasps the gas tip holder 50, for example by the lower end, such as at the tool receiving structure 54, and begins insertion of the gas tip holder 50 into the tubular heat exchanger 82.

As the gas tip 52 of the gas tip holder 50 reaches the beginning of the second portion 94 of the hollow passage 90 of the tubular heat exchanger 82, the beveled edges 80 direct the gas tip holder 50 into the second portion 94. The O-ring 70 in the groove 68 engages the sides of the second portion 94 of the hollow passage 90 of the tubular heat exchanger 82, and slightly resists insertion of the gas tip holder 50 into the tubular heat exchanger 82, but does not completely resist such insertion. Moreover, the engagement of the O-ring 70 with the second portion 94 assures alignment of the top end of the gas tip holder 50 within the tubular heat exchanger 82.

Further insertion of the gas tip holder 50 into the tubular heat exchanger 82 causes the O-ring 72 in the groove 66 to engage the first portion 92 of the hollow passage 90 of the tubular heat exchanger 82. This additional engagement adds additional resistance, but does not prevent further insertion of the gas tip holder 50 relative to the tubular heat exchanger 82. Moreover, the engagement of the O-ring 72 with the first portion 92 provides additional alignment for the gas tip holder 50 within the tubular heat exchanger 82.

Moving the gas tip holder 50 a little more into the tubular heat exchanger 82 causes the O-ring 74 in the groove 64 to engage the first portion 92 of the hollow passage 90 of the tubular heat exchanger 82. This adds additional resistance to insertion of the gas tip holder 50 into the tubular heat exchanger 82, but does not completely resist that insertion.

Insertion then continues until the external threads 56 on the gas tip holder 50 engage the internal threads 86 on the tubular heat exchanger 82. The user may then rotate the gas tip holder 50 so that the external threads 56 engage the internal threads 86. If desired, a tool, such as a wrench or a ratchet, may be placed on the tool receiving structure 54 to tighten the gas tip holder 50 onto the tubular heat exchanger 82.

In practice, the inventors have found that a gas tip, such as the gas tip 52, has a tendency to become clogged during operation. This phenomenon is particularly true in a combustion process such as is conducted in the mosquito trap 20. In the mosquito trap 20, the combustion is at a very low rate, such as at 1000 British thermal units (Btu's) per hour, and thus the flow of gas through the gas tip 52 is very slow. However, to maintain adequate pressure in the system, the orifice for the gas tip 52 must be very small, such as three thousandths of an inch. The inventors have found that such a small orifice has a tendency to become clogged over prolonged use. It is believed that the clogging of the orifice is caused by gas impurities. Moreover, it has been found that the clogging increases as the temperature of the gas tip 52 increases. For this reason, the tubular heat exchanger 82 is helpful, because it provides a structure that permits the gas tip holder 50, and thus the gas tip 52, to be cooled. This cooling is provided in part by conduction from the external threads 56 to the internal threads 86.

In addition, gas flow through the tubular heat exchanger 82 provides a cooling effect. To this end, a chamber 102 is provided between the O-rings 70, 72 and the gas tip holder 50 and the tubular heat exchanger 82. Gas entering the tubular heat exchanger 82 through the opening 96 flows into the chamber 102 and cools the gas tip holder 50. Gas also flows from the chamber 102 through the opening 78 in the gas tip holder 50 and into the hollow passage 76 of the gas tip holder 50. This gas eventually flows out of the orifice for the gas tip 52 and into the combustion chamber 36.

In addition to this cooling effect, the arrangement and configuration of the gas tip holder 50 and the tubular heat exchanger 82 provides easy insertion and attachment of the gas tip holder 50 to the tubular heat exchanger 82. To this end, the gas tip holder 50 is substantially long and includes the O-rings 70, 72, and 74 for aligning the gas tip holder 50 within the tubular heat exchanger 82. The alignment provided by the O-rings 70, 72, 74 and the length of the gas tip holder 50 aid in proper matching of the external threads 56 of the gas tip holder 50 with the internal threads 86 of the tubular heat exchanger 82. In this manner, a user may insert the gas tip holder 50 into the tubular heat exchanger 82 and may be assured by continuing insertion that the external threads 56 will eventually come into proper engagement with the internal threads 86. Moreover, the length of the gas tip holder 50 and the tubular heat exchanger 82, coupled with the engagement of the O-rings 70, 72, 74 with the hollow passage 90 of the tubular heat exchanger 82 assures that the external threads 56 will not be cross-threaded within the internal threads 86.

Although the second O-ring 74 does not form a barrier for the chamber 102, it serves as a backup if there is failure of the first O-ring 72. In accordance with an embodiment of the invention, as described above, the second O-ring 74 and the other O-rings 70, 72 are spaced so that they progressively engage the inside of the tubular heat exchanger 82, permitting a user to insert the gas tip holder 50 with progressive resistance, instead of working against a large amount of resistance upon initial insertion. The O-rings 70, 72, and 74 engage the inside of the hollow passage 90 of the tubular heat exchanger 82 in succession. As such, a user does not encounter a great deal of initial resistance to insertion of the gas tip holder 50 into the tubular heat exchanger 82. However, by successively engaging the inside of the hollow passage 90, each of the O-rings 70, 72, and 74 may be arranged for tight engagement with the inside of the hollow passage, and resistance is maximal only for the last bit of insertion of the gas tip holder 50.

As described above, the gas tip holder 50 may be attached to the tubular heat exchanger 82 using a single tool. Alternatively, the gas tip holder 50 may be hand tightened into the tubular heat exchanger 82. If desired, a different structure that is particularly well suited for tightening by hand may be provided at the bottom of the gas tip holder 50 instead of the tool receiving structure 54. As an example, a wing nut or other structure that provides easy gripping for the user may be provided at the bottom of the gas tip holder 50. As such, no tools may be needed for installing the gas tip holder 50.

In accordance with an embodiment of the invention, the gas tip holder 50 may be installed without having to dismantle the combustion chamber 36 or take apart the upper housing 26. Instead, a user may simply reach under the upper housing 26 and insert the gas tip holder 50 into the tubular heat exchanger 82. An already-installed gas tip holder 50 may be removed just as easily.

The gas tip holder 50 shown in the drawings is but one embodiment that may be utilized, and other embodiments may be configured to utilize some or all of the advantages of the gas tip holder 50. As an example, a gas tip holder may be directly attached to a gas line, such as the gas line 98, may be short, and may snap into place.

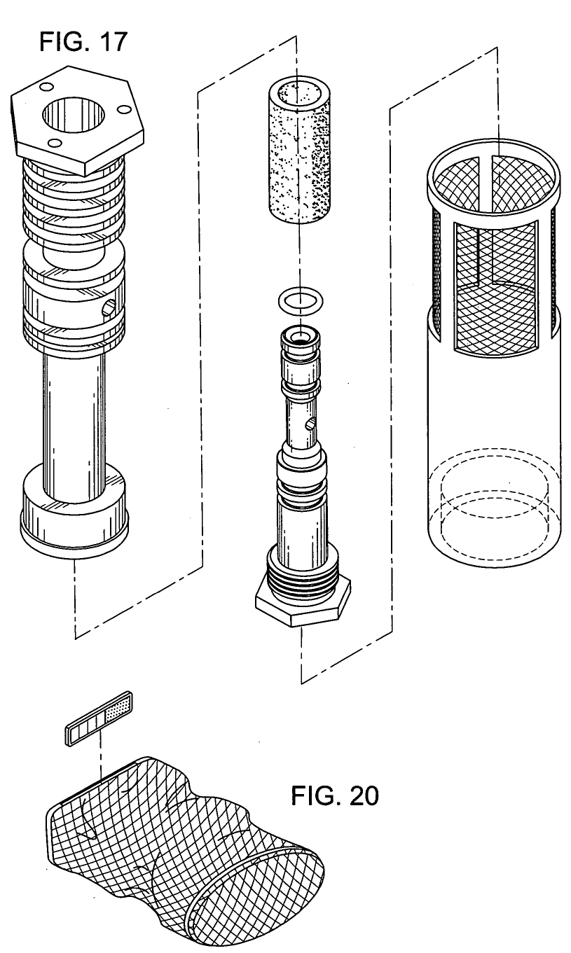

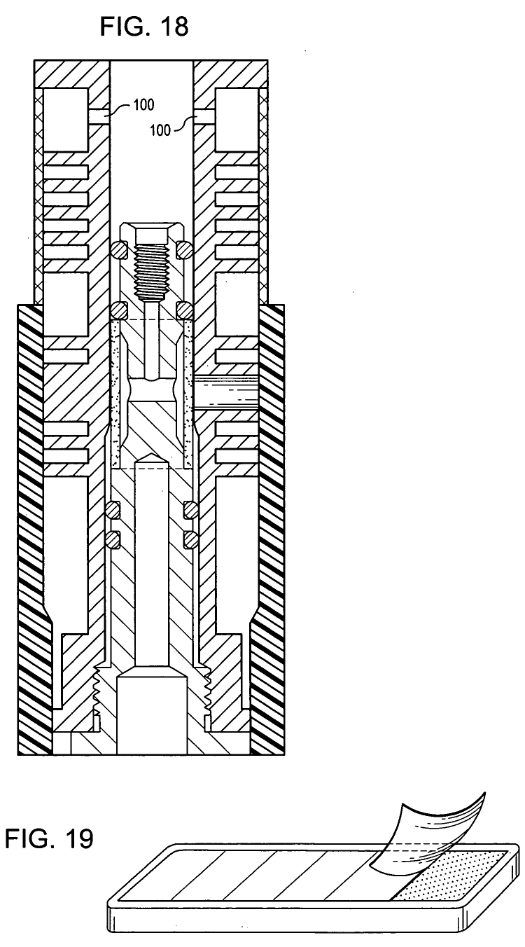

An alternate embodiment of a gas tip holder 200 is shown in FIGS. 17 and 18. The gas tip holder 200 is very similar to the gas tip holder 50, with the addition of a narrowed portion 202 adjacent a gas opening 204 (similar to the gas opening 78 in the gas tip holder 50). The narrowed portion 202 includes shoulders 206, 208 at opposite ends. A groove 210 is positioned upward from the shoulder 208. The groove 210 is configured to receive an O-ring 212, as is further described below.

In accordance with an embodiment of the invention, a microporous filter, shown in FIG. 17 as a cylindrical microporous filter 214, is provided between gas input for the system (e.g., the gas line 98) and the gas tip 52. The microporous filter 214 prevents impurities in the gas stream from reaching the gas tip 52. In this manner, plugging of the gas tip 52 by impurities in the gas stream is prevented, or at least delayed.

In accordance with an embodiment of the invention, the microporous filter 214 is a porous plastic, such as an ultra high molecular weight polyethylene. As an example, the microporous filter 214 may have a porosity of 40-50 microns.

To install the microporous filter 214 shown in the drawings, the microporous filter 214 is slid over the top end of the gas tip holder 200 until it is arranged over the shoulder 206. As can be seen in FIG. 18, the microporous filter 214 is of a length so that it also extends over the shoulder 208 in this position. The O-ring 212 is then snapped in place, and is utilized to hold the microporous filter 214 in position.

The positioning of the microporous filter 214 in FIGS. 17 and 18 prevents gas from reaching the gas tip 52 unless the gas flows through the opening 96 in the tubular heat exchanger 82, through the microporous filter 214, and into the gas opening 204. The large surface area of the microporous filter 214 permits it to filter for quite some time after some pores on the microporous filter 214 have been clogged.

The microporous filter 214 may be replaced as part of a maintenance program, or the gas tip holder 200 and the microporous filter 214 may together be replaced as part of a regular maintenance program.

Although shown as shaped like a cylinder, the microporous filter 214 may be formed in several different shapes, including as a flat panel that covers either of the openings 96, 204. A suitably shaped microporous filter 214 may otherwise be located anywhere between the gas source and the gas tip 52.

In accordance with an embodiment of the invention, a bug and debris screen 220 (FIG. 17) is provided for keeping spiders, other insects, and foreign debris out of the tubular heat exchanger 82 and/or the gas tip holder 200. In the embodiment shown in FIG. 17, the bug and debris screen 220 includes a cylindrical housing 222 having three openings 224 at a top end. Screen material 226 fits into the three openings 224.

In accordance with an embodiment of the invention, the bug and debris screen 220 fits around the tubular heat exchanger 82 and snap fits into place against the base of the tubular heat exchanger 82. The screen material 226 aligns outside the Venturi holes 100 (see FIG. 18), blocking debris and other matter from entering the Venturi holes 100. In this manner, adequate flow of air into the tubular heat exchanger 82 is assured.

The bug and debris screen 220 may be removed on a regular basis and the screen material 226 may be cleaned so as to assure that air flow to the Venturi holes 100 is not blocked.

The bug and debris screen 220 may be provided in other structures, and does not have to fit around or against the tubular heat exchanger 82. However, the configuration shown in the drawings is particularly well suited for use in a mosquito trap (e.g., the mosquito trap 20) including the tubular heat exchanger 82, and permits easy replacement and cleaning of the bug and debris screen 220.

FIG. 3 shows a general overview of airflow for the mosquito trap 20. In general, the fan 44 draws air into the mosquito trap 20 via the capture jar 34, as described below. The description will now focus on the flow of air out of the mosquito trap 20.

The air drawn in by the fan 44 blows through the straightener 46 and into and through the heat exchanger 40. As can best be seen in phantom in FIG. 2, the straightener 46 is a round, short cylinder having a series of vertically aligned fins 104 (also shown in FIG. 3) extending upward therefrom. The vertically aligned fins 104 extend radially outward to form spokes for the straightener 46. In practice, these fins 104 cause air blowing up from the fan 44 to be distributed evenly through the vertical cooling fins 82 of the heat exchanger 40. The inventors have found that without the use of the straighteners 46, air tends to exit only at the corners of the heat exchanger 40. However, by using the straighteners 46, airflow is more even, and heat removal provided by the fan 44 is maximized. Other structures may be used to provide the function of the straighteners 46.

As described above, the heat exchanger 40 provides a cold sink for the thermoelectric modules 38. In addition, some of the air directed through the heat exchanger 40 blows into a snorkel 106. As can be seen in FIG. 3, the snorkel 106 extends from the top of the heat exchanger 40 and attaches to the top of the column 24. The column 24 is hollow, and thus a continuous conduit is created between the top of the heat exchanger 40 and the bottom of the column 24. From there, the air flows downward and out of a diffuser 122, described below.

Air in the snorkel 106 is mixed with combustion gases from the combustion chamber 36. To this end, the snorkel 106 includes an opening 108 in its bottom surface for receiving a top portion of the combustion chamber 36. Details of construction of the combustion chamber 36 are shown in FIG. 6. The combustion chamber 36 includes a rear plate 112 that fits over the rear portion of a fire box 114. An opening 116 is provided at the bottom of the fire box 114. The connector plate 88 of the tubular heat exchanger 82 is connected around the opening 116 so that the inside of the fire box 114 is in fluid communication with the hollow passage 90 of the tubular heat exchanger 82. Catalytic beads 118 are positioned within the fire box 114. A top portion of the fire box 114 tapers to form a chimney 120 for the fire box 114. The rear plate 112 covers a majority of the chimney 120, but a top portion of the chimney 120 is left open to permit combusted gases to leave the combustion chamber 36. This top portion of the combustion chamber 36 is mounted within the opening 108 of the snorkel 106, as can be seen in FIG. 3.

During the combustion process, gas is supplied to the combustion chamber 36 via the gas tip holder 50 and the tubular heat exchanger 82. The gas flows through the gas tip holder 50, and air and turbulence is provided via the Venturi holes 100. The gas flows into the combustion chamber 36 and provides a fuel by which the catalytic beads 118 may remain lit. The lighting process is described below. The combustion within the combustion chamber 36 provides combusted gases, including carbon dioxide. These combusted gases leave the combustion chamber 36 through the opening in the chimney 120 provided by the rear plate 112. The gases thus flow into the snorkel 106, and are mixed with the air flowing through the heat exchanger 40 and into the snorkel 106. The mixed air and combusted gases flow down to the bottom of the column 24 to the diffuser 122.

The diffuser 122 is mounted on the bottom of the base 22 and includes an upper disk 124 with an opening (not shown) for fitting onto the bottom of the column 24. A lower disk 126 is faced opposite the upper disk 124, and a perforated screen 128 extends around the perimeter of the upper and lower disks 124, 126.

As the air and combustion gases flow down to the diffuser 122, they flow through the opening in the upper disk 124 and flow out of the perforated screen 128 in a direction perpendicular to the flow down through the column 24. This flow of air is generally shown by the arrows in FIG. 3.

In an alternate embodiment, the diffuser 122 is not used. In this embodiment, the exhaust flows out of the column 24 without being directed sideways (except, perhaps, by the ground). A screen may be provided for preventing insects or animals from entering the column 24.

In the embodiment shown, the diffuser 122 is approximately 18 to 30 inches from the upper housing and an insect inlet 175 (FIG. 3, described further below). Routing the gases to the bottom of the base 22 and away from the insect inlet 175 has many advantages. First, the gases are removed from the fan 44 and its suction, and thus remain concentrated for a longer period of time, which thereby permits a greater attraction of mosquitos and other biting insects. The inventors have found that routing the combustion gases to this location provides enhanced attraction of mosquitos and biting insects. It is believed that this enhanced attraction is due in part to the routing of the exhaust to a location that is removed from the fan 44, thus permitting the exhaust gases to be in the atmosphere for a longer period of time. It is also believed that enhanced attraction is due in part to the fact that the exhaust is released at a low position, below the upper housing 26 where trapping takes place, thus permitting the exhaust to flow upward and form a plume around the bottom of the mosquito trap 20.

The combustion gases may be routed to the base 21 using another conduit or mechanism, if desired. In addition, as used herein, “column” is meant to connote any vertical structure that supports the upper housing 26 above the base 21, and includes, but is not limited to a tube, a cylinder, a rod, or combinations and/or multiples of these or other structures.

The mixture of air that flows from the heat exchanger 40 and into the snorkel 106 mixes with combustion gases from the combustion chamber 36 and provides a cooled mixture of air and combustion gases such as carbon dioxide. In accordance with an embodiment of the invention, the fan 44 and the snorkel 106 are configured and arranged such that the cooling provided by the air produces a mixture that exits the diffuser 122 at a temperature that attracts mosquitos and other biting insects, for example in a range above ambient temperature and below 115 degrees Fahrenheit.

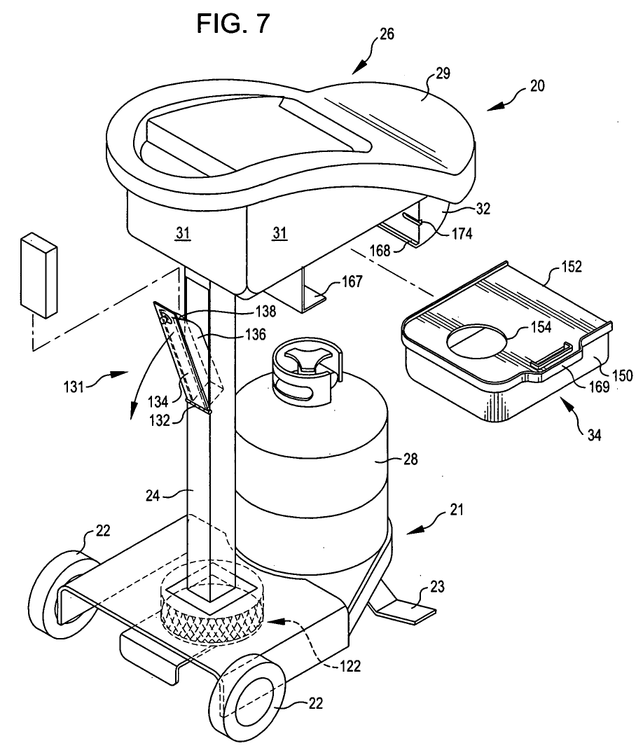

In accordance with an embodiment of the invention, an octenol/attractant access opening 131 (FIG. 7) is provided on the side of the column 24. The octenol/attractant access opening 131 includes a hinge 132 and a panel 134. On the inside of the panel 134 are mounted a pair of side walls 136, 138.

The octenol/attractant access opening 131 is arranged in the column 24 so that an attractant placed between the side walls 136, 138 is positioned in the airflow of air and combusted gases flowing from the snorkel 106 and through the column 24. In this manner, attractant, such as octenol, may be added to the flow of exhaust that exits via the diffuser 122.

As is known, octenol is an alcohol that is given off by mammalian blood hosts. Attractants placed between the side walls 136, 138 may be provided in a tray or other container, or may be provided as a standalone device that contains the attractant alone. One example of an octenol chemical solution may be one of many existing octenol lures produced by BioSensory Insect Control Corporation of Willimantic, Conn., such as is described by BioSensory's U.S. Pat. No. 5,799,436, incorporated herein by reference. Chemical insect attractants other than octenol may also be used. Preferably, regardless of the insect attractant used, the solution that is placed behind the octenol/attractant access opening 131 is formulated so that it slowly releases attractant as a result of exposure to air. Also preferably, the octenol or other attractant may be supplied in such an amount that it takes several days, or even a couple of weeks, to evaporate under the operating temperature of the mosquito trap 20.

As an example, an attractant A is shown in FIG. 7, with the octenol/attractant access opening 131 hinged open. The attractant A may be installed between the side walls 136, 138 while the octenol/attractant access opening 131 is open. The octenol/attractant access opening 131 is then closed so that the attractant A is maintained within the column 24, as is shown in FIG. 3.

Other support structures for an attractant may be provided on the back side of the octenol/attractant access opening 131. As examples, instead of the side walls 136, 138, a hook, a single side wall, an adhesive backing, a connector, or any other support structure for an attractant may be provided. In addition, the attractant need not be attached to the octenol/attractant access opening 131. If the attractant A is not attached to the octenol/attractant access opening 131, it may be attached to something inside the column 24, or may otherwise rest within the column 24. However, by attaching the attracting to the octenol/attractant access opening 131, the attractant may be easily removed and/or installed in the column 24.

In addition, other structures may be provided for installing the attractant A in the column 24. As an example, the attractant A may be installed in an opening in the column 24, and a back side of the attractant A may close off the column 24. Also, if desired, the attractant A may be located in the diffuser 122 or in the snorkel 106. A variety of different options is available for providing insect attractant with the exhaust plume.

As an alternative to placing an attractant in the exhaust flow, an attractant may be provided at a different location close to the base 21 or the upper housing 26. The attractant may be routed to a desired location, for example by a fan or the fan 44, or may be supplied in another manner. As one example, an attractant may be provided at a trap inlet for the housing, so as to lure mosquitos and biting insects to the trap inlet after they have been attracted by the exhaust plume.

In accordance with an embodiment of the invention, the attractant may be provided in an attractant tray 240 (FIG. 19). In the embodiment shown in FIG. 19, the attractant tray 240 includes a series of removable panels 242.

A subset of the panels 242 may be removed to expose a desired amount of attractant 244. By removing the proper number of panels 242, the attractant stream leaving the mosquito trap 20 may be adapted for a particular insect, for a particular region of the country, and/or for particular conditions. Moreover, if desired, the attractant tray 240 may be configured so as to receive a number of different attractants (not shown), whereby removal of some of the panels 242 exposes one attractant, and removal of a different panel or panels 242 exposes a different attractant. The panels 242 may be color coded or may include instructions thereon or may otherwise include indications so that a user will know how to prepare the attractant tray 240 for a particular insect, region or condition.

In the embodiment shown in FIG. 19, the attractant 244 is shown as a large continuous mass of substance. However, if desired, the attractant tray 240 may be nearly completely closed, with slits or other openings (not shown) optionally provided that would be exposed by removal of respective panels 242.

Utilizing the attractant tray 240, the mosquito trap 20 may be configured to provide a particular attractant stream in accordance with scientific evidence of effective attractant streams for insects, regions and/or conditions. One or more of such attractant trays may be utilized with the mosquito trap 20.

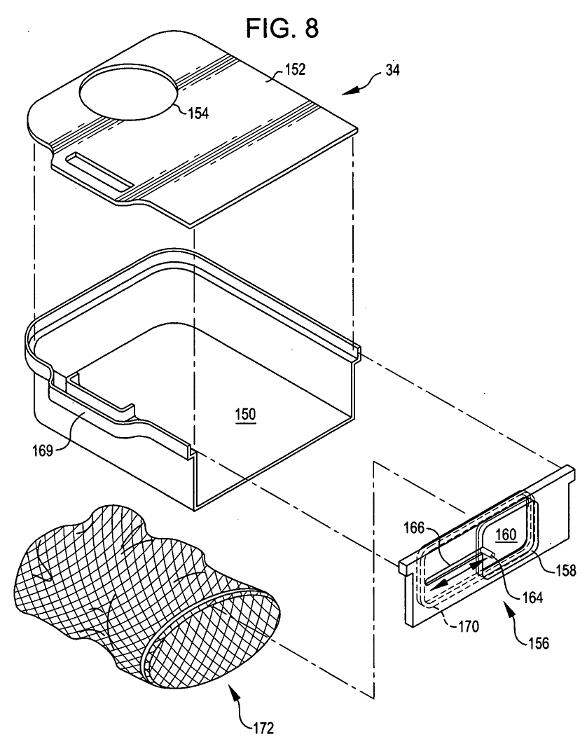

We turn now to the capture jar 34. Details of the capture jar 34 are shown in FIG. 8. The capture jar 34 includes a capture tray 150 and a lid 152 that fits over the capture tray 34. An opening 154 is provided at one end of the lid 152 and, when the capture jar 34 is in place in the mosquito trap 20, fits just below the fan 44.

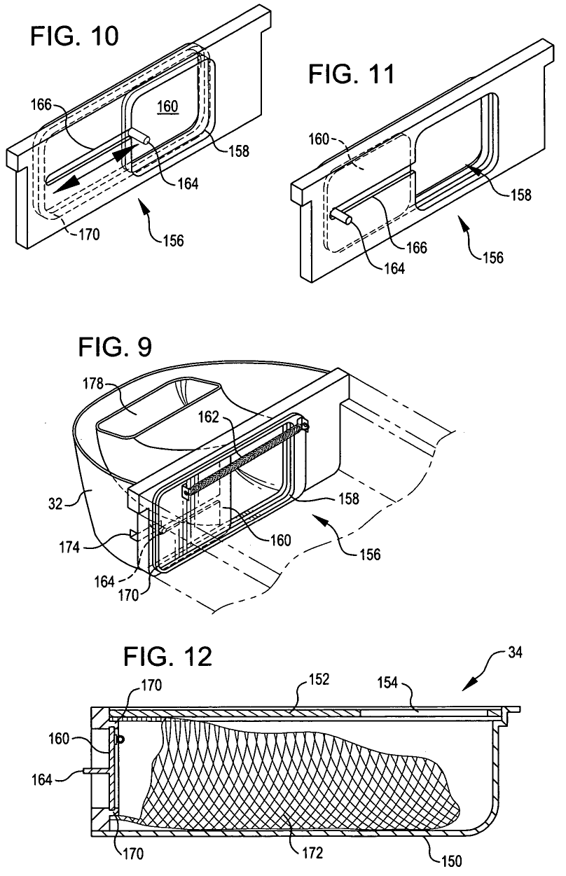

An end panel 156 fits against an open side of the capture tray 150 and along the respective edge of the lid 152. The end panel 156 includes an opening 158. A door 160 is mounted for sliding movement so that it may selectively close the opening 158. The door 160 is biased into a position to close the opening 158 by a spring 162. As can be seen in FIG. 9, the spring 162 is connected to both the door 160 and the end panel 156, thus biasing the door 160 into the closed position.

A protrusion 164 (FIGS. 10 and 11) extends out of a front side edge of the door 160 and fits into a slot 166 that is connected to the opening 158 on the end panel 156. The protrusion 164 moves along the slot 166 as the door 160 moves between the opened and closed positions.

As can be seen in FIG. 7, when the capture jar 34 is assembled, it fits underneath the upper housing 26 and it rests on a pair of flanges 167, 168. Another structure may be provided for supporting the capture jar 34, including but not limited to an opening in the upper housing 26, a shelf, or another support structure. A handle 169 is formed in the capture tray 150 for ease of removal and installation of the capture jar 34 on the flanges 167, 168.

Turning back to FIG. 9, the end panel 156 includes a rim 170 surrounding the door 160. The rim 170 is configured to receive the front end of a net bag 172 (FIG. 12). The net bag 172 may include a drawstring, an elastic string, clips, or other means for holding the net bag 172 on the rim 170. Other receptacles may be used in the place of the net bag 172, but the net bag 172 provides an inexpensive, easy-to-use structure.

To install the capture jar 34, the net bag 172 is installed on the rim 170 of the end panel 156, and the end panel 156 is assembled with the capture tray 150 and the lid 152. The assembled capture jar 34 may then be inserted onto the flanges 167, 168 and under the upper housing 26. If desired, a user may grip the handle 169 to direct the capture jar 34 onto the flanges 167, 168.

When the net bag 172 is installed on the rim 170, the door 160 is already shut and remains so by the bias of the spring 162. When the capture jar 34 is installed underneath the upper housing 26, the protrusion 164 on the door 160 engages a groove 174 (FIGS. 7 and 9) on the back side of the nose piece 32. The groove 174 permits limited travel of the protrusion 164 as the capture jar 34 is inserted underneath the upper housing 26. When the protrusion 164 may no longer advance because it has reached the end of the groove 174, the capture jar 34 is moved further inward, and the door 160 opens because of the movement of the protrusion 164 relative to the capture jar 34. As such, when the capture jar 34 is installed underneath the upper housing 26, the door 160 is automatically opened.

In accordance with an embodiment of the invention, the net bag 172 may be impregnated with an attractant material such as octenol. Impregnating fabric with chemicals or other substance is well known and a substance such as octenol or another attractant could be impregnated into the net bag 172. Air flowing through the impregnated net bag 172 would thereby produce an octenol stream. This octenol stream would flow through the heat exchanger 40 and may then exit the top of the mosquito trap 20 or flow through the column 24. In either event, the attractant is released by the mosquito trap 20, and therefore is available for attracting of mosquitos and other biting insects.

Impregnating the net bag 172 has an advantage in that the net bag 172 will be routinely emptied or replaced. The net bag 172 may be impregnated with a sufficient amount of attractant so that the attractant lasts as long as the expected lifespan of the net bag 172. In this manner, a user may replace the net bag 172 and at the same time is providing a fresh supply of attractant for the mosquito trap 20. This avoids the additional maintenance of routinely changing the attractant A and/or the attractant tray 240 when the attractant is provided at a different location on the mosquito trap 20.

In accordance with another embodiment of the invention, a net bag 250 (FIG. 20) may include a pocket 252 on a portion of the net bag 250, such as at the back or front edge of the net bag. The pocket 252 may be configured to receive an attractant or attractant holder, such as the attractant A and/or the attractant tray 240. Multiple attractant trays 240 may be inserted into the pocket 252, or different types of attractants may be inserted into the pocket 252. The pocket 252 may include a closure, such as a hook and loop closure (not shown), or other suitable mechanisms to close or otherwise attach the attractant to the net bag 250.

The net bag 250 also is advantageous in that a user may check or replenish the attractant supply at the time of replacing or emptying the net bag 250. Again, this feature permits a single maintenance cycle to refresh or check the attractant and replace or empty the net bag 250.

Airflow into the upper housing 26 of the mosquito trap 20 is shown in FIG. 3. Mosquitos and biting insects that are attracted to the exhaust plume exiting the diffuser 122 are sucked into the insect inlet 175 at the front edge of the cover 29. The insect inlet 175 opens downward, which is consistent with the flight pattern of mosquitos. That is, a mosquito, once disoriented or feeling like it is trapped, has a tendency to fly upward. Thus, mosquitos attracted to the exhaust plume exiting the diffuser 122 attempt to fly upward and are sucked into the insect inlet 175. Air sucked into the insect inlet 175 moves upward into the upper housing 26 and then downward into and through an opening 176 (FIGS. 3 and 2) at the front edge of the bottom plate 30. This opening 176 leads to a chute 178 (FIGS. 3 and 9) that is mounted in the nose piece 32 and extends to the opening 158 in the end panel 156. Mosquitos drawn in through the chute 178 are sucked into the capture jar 34 through the opening 158 and into the net bag 172. Suction for the entire system is provided via the fan 44 through the opening 154 in the lid 152.

After a period of time, the net bag 172 will be full of mosquitos and/or biting insects and will need to be emptied. Often, mosquitos or biting insects that are trapped in the net bag will dehydrate while the mosquito trap 20 is operating. However, when the net bag 172 needs replacing, there may be a few live mosquitos or biting insects in the net bag 172. The spring loaded door 160 prevents these mosquitos and biting insects from escaping when the capture jar 34 is removed from under the upper housing 26.

Withdrawal of the capture jar 34 from the underside of the upper housing 26 permits the protrusion 164 to slide back along the slot 166, permitting the door 160 to close over the opening 158. As such, the net bag 172 and the end panel 156 provide a complete enclosure for the captured mosquitos and/or biting insects.

In accordance with an embodiment of the invention, the end panel 156 and the full net bag 172 are detached from the remainder of the capture jar 34 so that an additional end panel 156 and net bag 172 may be used in their place. Otherwise, if the net bag 172 were immediately removed from the rim 170 of the end panel 156, the live mosquitos and/or biting insects may escape and may bite the user. To avoid this, by providing an additional end panel 156, the full net bag 172 and attached end panel 156 may be set aside until all bugs have died in the net bag 172. The net bag 172 may then be removed and thrown away or may be emptied for later re-use.

Although the above embodiment is described with reference to the end panel 156 being removed, any portion of the capture jar 34 may be removed and set aside with the net bag 172. To this end, as used herein and in the claims, a removable “panel” is to be construed as any portion of the capture jar 34.

Although described with reference to the capture jar 34, other insect traps or killing mechanisms may be used with the mosquito trap 20. A bug “zapper” may be provided, such as the type utilizing an electrified grid.

Alternatively, a sticky adhesive assembly such as is described in commonly-owned U.S. Pat. No. 6,594,946.

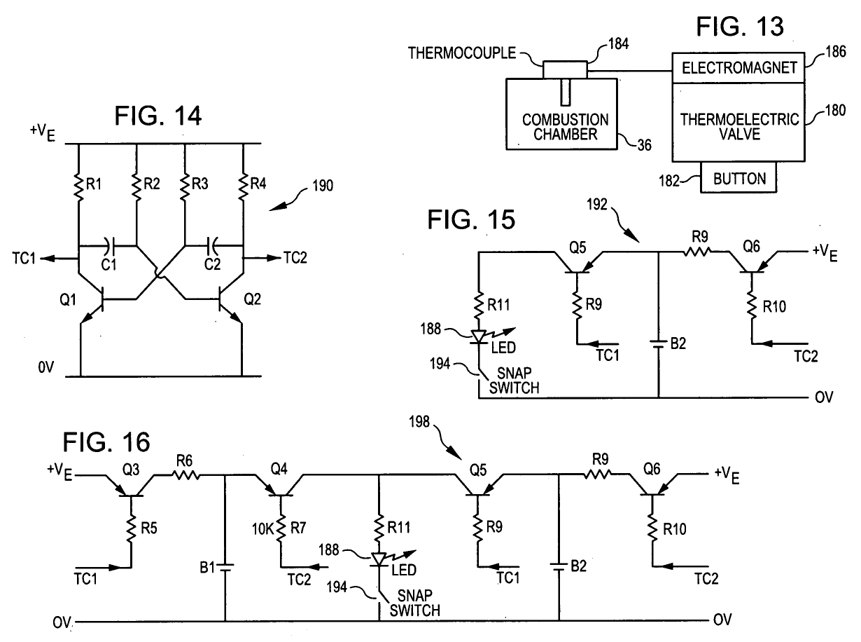

In accordance with an embodiment of the invention, a thermoelectric valve 180 (see FIGS. 6 and 13) is used to control the flow of gas into the gas tip holder 50 and therefore the combustion chamber 36. The function, structure, and operation of thermoelectric valves are well known, but a simplified description is given here for the benefit of the reader. In general, thermoelectric valves, such as the thermoelectric valve 180, include a normally closed valve. A button 182 is connected to the normally closed valve for manual opening of the valve. In addition, an electromagnet 186 (FIG. 13) is connected to the valve for latching the valve into the opened position.

The electromagnet 186 is connected to a thermocouple, such as the thermocouple 184 shown in FIG. 13. The thermocouple 184 is heated within the combustion chamber 36, and may, for example, have an end that extends into the catalytic beads 118. As is known, a thermocouple is a temperature transducer consisting of two dissimilar metals welded together at one end to form a junction that when heated will generate a voltage. In this particular embodiment, the voltage is used to switch the electromagnet 186 to open the thermoelectric valve 180.

Generally, the thermoelectric valve 180 may be opened in two ways. First, it may be opened by pressing and holding the button 182. Releasing the button 182 causes the thermoelectric valve 180 to close. Second, the thermoelectric valve 180 may be opened by the thermocouple 184 reaching a predetermined temperature. When the thermocouple 184 reaches this temperature, it supplies enough power to the electromagnet 186 having sufficient power to hold the thermoelectric valve 180 open.

In accordance with one embodiment shown, the thermocouple 184 is mounted so that its tip is located just above the catalytic beads 118. At this location, it is heated very quickly after combustion begins in the combustion chamber 36. However, in order to begin the combustion process, a user must press and hold the button 182 and must continue to hold this button 182 until the thermocouple 184 has reached the appropriate temperature so that adequate voltage is supplied to the electromagnet 186 to hold the thermoelectric valve 180 open. In accordance with an embodiment of the invention, a circuit is provided for providing a signal to a user that the user may release the button 182. Examples of two such circuits 192, 198 are described together with FIGS. 14-16.

The signal may be, for example, lighting a light, such as a LED lamp 188 (FIGS. 15-16). Other examples include audible signals, including beepers and recorded messages, or anything else that conveys notice. As another example, a light or other signal may be turned off.

In accordance with an embodiment of the invention, an astable multivibrator circuit 190 is utilized to generate voltage signals that may be used in either circuit 192 or 198 to charge a battery or batteries that are used for lighting the LED lamp 188.

In general, the function and operation of an astable multivibrator circuit such as the astable multivibrator circuit 190 is known, but its operation is described briefly here for the benefit of the reader. For an astable multivibrator circuit, two transistors Q1 and Q2 are coupled to each other through capacitors C1 and C2. These transistors Q1 and Q2 are alternatively on and off, with one being on and the other off at all times. Whichever transistor is off at any moment cannot remain off indefinitely; its base will become forward biased as the capacitor connected to that base charges toward the voltage applied to the circuit, in this case, the voltage of the thermoelectric modules 38, indicated by V_{E}. As the capacitor reaches that voltage, the associated transistor will turn on, thereby turning the other transistor off.

As an example, a moment may be picked when Q1 has just turned off and Q2 is on, and C2 is then charged through a resistor R3 toward V_{E}. However, the moment that C2 charges enough to provide forward bias to the base of Q1, Q1 turns on and the voltage drop of V_{E} in Q1's collector voltage is coupled through C1 to the base of Q2. This turns Q2 off at once. Now Q2 is held off while C1 charges through a resistor R2, until Q2's base becomes forward biased. At that point, the transistors switch states again and the whole process begins anew. This process continues so that output signals at TC1 and TC2 are complementary square waves. These square waves may be set at a desired frequency based upon the values for the resistors R1-R4 and the capacitors C1-C2, but in one embodiment are complementary square waves 100 milliseconds apart from one another.

Although the embodiment shown in FIG. 14 utilizes an astable multivibrator circuit, any other circuit may be utilized that produces alternating signals. The astable multivibrator circuit is one way to produce the signals, and is relatively inexpensive and reliable. As an alternative, a circuit may be provided that produces a single signal that goes up and down (or on and off), and the outputs TC1 and TC2 may be based upon the opposites states of the single signal.

The outputs TC1 and TC2 may be used in the circuit 192 of FIG. 15 to light the LED lamp 188. In this circuit 192, the signal TC1 is coupled to the base of a first capacitor Q5 and the signal TC2 is coupled to the base of a second capacitor Q6. When Q6 is on (i.e., TC2 voltage signal is low), then Q5 is off (i.e., the TC1 signal is high). In this state, the voltage V_{E} for the thermoelectric modules 38 charges the battery B2. When the signals TC1 and TC2 oscillate, the voltage V_{E} from the thermoelectric modules 38 is removed from the battery B2 and the battery B2 supplies a current to the LED lamp 188. In this manner, the circuit 192 alternates between the voltage V_{E} charging the battery B2, and the voltage V_{E} being cut from the battery B2, with the battery B2 supplying power to the LED lamp 188. As can be understood, this alternating cycle will cause a flashing of the LED lamp 188. However, if desired, the cycles between changes of the signals TC1 and TC2 may be set to such a short amount of time that the flashing of the LED lamp 188 is hardly noticeable.

For the LED lamp 188 to indicate that the combustion chamber 36 is sufficiently heated so that a user may release the button 182 on the thermoelectric valve 180, a snap switch 194 is provided in the circuit 192. The snap switch 194 is a thermal switch that may be, for example, mounted on the side of the combustion chamber 36, as is shown in FIG. 2. This snap switch 194 is a normally opened switch that snaps closed once the snap switch 194 reaches a particular temperature. If this temperature has not been reached, the LED lamp 188 will not be supplied power by the battery B2. Thus, a user would know to hold the button 182 until the snap switch 194 is engaged, and the LED lamp 188 illuminates.

The LED lamp 188 remains on during operation and permits the user to determine by visual inspection whether or not the mosquito trap 20 is operating. Because the LED lamp 188 is powered by the battery B2 instead of the voltage V_{E} from the thermoelectric modules 38, the LED lamp 188 is bright upon initial lighting, and a user should not have difficulty seeing that the LED lamp 188 is lit.

In accordance with another embodiment of the invention, the circuit 198 in FIG. 16 may be used to supply power to the LED lamp 188. The right half of the circuit 198 in FIG. 16 is identical to the circuit 192 in FIG. 15. The left half of the circuit 198 in FIG. 16 is a mirror image of the right half of the circuit 198. However, instead of the signal TC2 being used to operate a transistor to charge the battery B2, the signal TC1 is used to charge the battery B1. Similarly, the signal TC2 is used to release the voltage V_{E} from the thermoelectric modules 38 from the battery B1, and to permit the battery B1 to power the LED lamp 188. In this manner, the left half of the circuit 198 supplies power to the LED lamp 188 via the battery B1 while the right half of the circuit is charging the battery B2 with the voltage V_{E}. When the cycles for the signals TC1 and TC2 change, the battery B2 supplies power to the LED lamp 188, and the voltage V_{E} charges the battery B1.

The circuit 198 in FIG. 16 has an advantage over the circuit 192 in FIG. 15 in that a constant supply of power, albeit alternating, is supplied to the LED lamp 188. In this manner, the LED lamp 188 does not blink, but instead produces constant illumination. In addition, for both circuits 198 and 192, the LED lamp is powered by a battery or batteries, so that the lamp shines brightly when first lit.

If desired, the batteries B1 and/or B2 may be replaced with capacitors (not shown). The capacitors would perform a similar function to the batteries B1, B2, but would not be initially charged upon start-up.

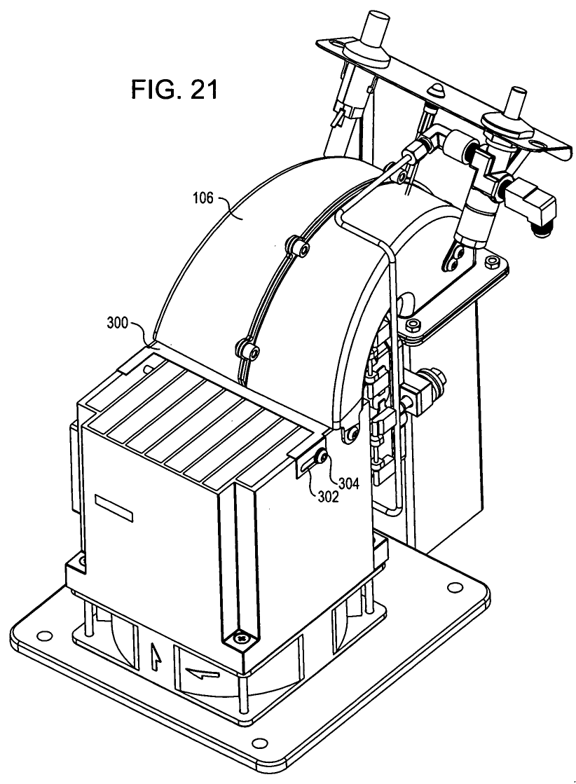

FIG. 21 shows a flow controlling shim 300 mounted on top of the heat exchanger 40 and slidable between the snorkel 106 and the heat exchanger. For example, the flow controlling shim 300 may include slots 302 that are slidably attached to fasteners 304 (when the fasteners are loosened) on the heat exchanger 40. By sliding the flow controlling shim 300 in and out, the amount of secondary air used to cool the combustion gasses, and mixed with the combustion gasses, may be adjusted. After the flow controlling shim 300 is set to the desired position, the fasteners may be tightened to maintain the flow controlling shim 300 in the desired position.

The flow controlling shim 300 may be used to fine tune the attractant plume as the unit is being assembled, allowing a manufacturer to set the concentration of the attractant and/or temperature of the attractant plume. In this manner, a manufacturer may also make several mosquito traps 20 having identical, or near identical, specifications.

By using the flow controlling shim 300 during assembly and measuring the plume concentration of CO₂, a manufacturer may also eliminate much of the tolerance stack-up and provide a uniform operating and performing mosquito trap 20.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An insect attracting apparatus, comprising:
a housing;
a combustion chamber mounted in the housing;
a gas tip configured to emit gas into the combustion chamber; and
a gas tip holder onto which the gas tip is mounted, the gas tip holder being removably mounted to the housing so that the gas tip holder may be removed without opening the housing.

2. The insect attracting apparatus of claim 1, further comprising a heat exchanger into which the gas tip holder is mounted.

3. The insect attracting apparatus of claim 2, wherein the heat exchanger is tubular in shape and comprises a plurality of radial fins.

4. The insect attracting apparatus of claim 3, wherein the gas tip holder and the heat exchanger form a chamber, and wherein gas enters the chamber and flows out of the gas tip.

5. The insect attracting apparatus of claim 4, further comprising at least two seals for connecting the heat exchanger and the gas tip holder, and wherein the chamber is formed at least in part by the heat exchanger, the gas tip holder, and the seals.

6. The insect attracting apparatus of claim 5, wherein the seals, the heat exchanger, and the gas tip holder are configured so that the seals provide progressive resistance to insertion of the gas tip holder into the heat exchanger.

7. The insect attracting apparatus of claim 5, wherein the number of seals is at least three.

8. The insect attracting apparatus of claim 2, wherein the gas tip holder and the heat exchanger form a chamber, and wherein gas enters the chamber and flows out of the gas tip.

9. The insect attracting apparatus of claim 1, wherein the gas tip comprises a tool receiving structure, and wherein the gas tip holder is removably mountable with a single tool.

10. The insect attracting apparatus of claim 1, wherein the gas tip is removably mountable without use of a tool.

11. The insect attracting apparatus of claim 1, wherein the insect attracting apparatus comprises a mosquito trap.

12. An insect attracting apparatus, comprising:
a combustion chamber;
a tubular heat exchanger mounted in fluid communication with the combustion chamber;
a gas tip holder onto which the gas tip is mounted, the gas tip holder being removably mounted within the tubular heat exchanger so that the gas tip holder may be removed without disassembling the combustion chamber.

13. The insect attracting apparatus of claim 12, wherein the gas tip holder and the tubular heat exchanger form a chamber therebetween, and wherein gas enters the chamber and flows out of the gas tip.

14. The insect attracting apparatus of claim 13, further comprising at least two seals for connecting the heat exchanger and the gas tip holder, and wherein the chamber is formed at least in part by the heat exchanger, the gas tip holder, and the seals.

15. The insect attracting apparatus of claim 14, wherein the seals, the heat exchanger, and the gas tip holder are configured so that the seals provide progressive resistance to insertion of the gas tip holder into the heat exchanger.

16. The insect attracting apparatus of claim 14, wherein the number of seals is at least three, and at least two of the seals are positioned opposite the combustion chamber from the gas tip.

17. The insect attracting apparatus of claim 14, wherein the gas tip holder further comprises
a hollow passage therein, the gas tip being in fluid communication with the hollow passage, and
at least one opening between the hollow passage and the chamber, where gas enters the chamber, flows through said at least one opening into the hollow passage, and flows out of the gas tip.

18. The insect attracting apparatus of claim 12, wherein the gas tip comprises a tool receiving structure, and wherein the gas tip holder is removably mountable with a single tool.

19. The insect attracting apparatus of claim 12, wherein the gas tip is removably mountable without use of a tool.

20. The insect attracting apparatus of claim 12, wherein the insect attracting apparatus comprises a mosquito-trap.

21. A gas tip holder for an insect attracting apparatus that is removable without opening a housing or a combustion chamber for the insect attracting apparatus.

22. An insect attracting apparatus, comprising:
a combustion chamber;
a gas tip configured to emit gas into the combustion chamber;
a gas source for supplying gas to the gas tip; and
a microporous filter positioned between the gas source and the gas tip.

23. The insect attracting apparatus of claim 22, further comprising a gas tip holder onto which the gas tip is mounted, and wherein the microporous filter is mounted on the gas tip holder.

24. The insect attracting apparatus of claim 23, further comprising a heat exchanger into which the gas tip holder is mounted.

25. The insect attracting apparatus of claim 24, wherein the heat exchanger and the gas tip holder are generally tubular in shape and the microporous filter is cylindrical in shape and fits over the outside of the gas tip holder.

26. The insect attracting apparatus of claim 24, wherein the microporous filter is held in position by a seal.

27. The insect attracting apparatus of claim 24, wherein the gas tip holder and the heat exchanger form a chamber, and wherein gas enters the chamber, passes through the microporous filter, and flows out of the gas tip.
